(19) United States
(12) Patent Application Publication
(10) Pub. No.: US 2026/0332535 A1
(43) Pub. Date: Oct. 22, 2026

(54) Synchronized Data Network System, and Method for Initializing and Synchronizing Same

(71) Applicant: Rockwell Collins Deutschland GmbH, Heidelberg (DE)

(72) Inventors: Timo Reubold, Eberbach (DE); Heiko Engel, Eppelheim (DE)

(21) Appl. No.: 18/997,148

(22) PCT Filed: Jul. 19, 2023
(86) PCT No.: PCT/EP2023/070018

§ 371 Date: Jan. 20, 2025

(30) Foreign Application Priority Data
Jul. 21, 2022 (DE) 10 2022 118 267.3

(51) Int. Cl. H04L 47/56

(52) U.S. Cl. CPC H04L 47/56

(57) ABSTRACT

A synchronized data network system includes a data network that connects data network nodes to one another via direct bidirectional data transmission links between neighbouring data network nodes to exchange data, and an arbitrary node chain of the data network nodes having successive first, second and third data network nodes. The second data network node receives data transmitted on a first direct data transmission link between the first and second data network nodes from the first data network node on a data forwarding link, and forwards the data in transmit mode to the third data network node on a second direct data transmission link between the second and third data network nodes. The second data network node delays forwarding of the data on a single-hop data forwarding link between the first and third data network nodes, such that the hop latency is equal to a predetermined fixed common hop latency.

The invention relates to a synchronized data network system, in particular, a data network system in use as an avionics system data network for deterministic and potentially flight safety-relevant communication between the data network participants. Furthermore, the invention relates to a method for initializing and synchronizing the data network system.

When using data network components in an avionics system, there is often the requirement to enable or facilitate deterministic communication between the participants in the avionics system data network. This is usually a strict requirement, for example, in the case where communication is an essential part of the function with direct or indirect impact on flight safety. Determinism is an abstract term and is described in document DO-297 “Integrated Modular Avionics (IMA) Development Guidance and Certification Considerations”, Nov. 8, 2005, RTCA SC-200, EUROCAE WG-6 as “the ability to produce a predictable result based on previous operations, with the result occurring repeatably within a specified time window.

One approach on how a deterministic behavior of data network implementation can be achieved is through absolute control of network data traffic in time and space, which allows provision of a bandwidth guarantee for communication between any two participants in the network during a precisely defined period of time.

An essential part of achieving this is to ensure that each data network node in a data network system, which is connected to other data network nodes via a data network through respective direct data transmission links, has a common understanding of the current system time, with a defined minimum acceptable deviation in precision. For a deterministic data network system to function, it is therefore essential that all components or data network nodes contained in the data network are synchronized with one another and have a common time base. This common clock time can be achieved through various time synchronization tools, such as industry standard methods like the precision time protocol (PTP) and its corresponding enhancements for modern time-sensitive networks.

Industry standard methods of time synchronization (hereinafter simply referred to as synchronization) are optimized for use in complex, dynamically changing, open networks, and they require sophisticated methods to establish a common time base between all participants. In contrast, avionics network systems are often prefabricated and, moreover, are closed systems to limit complexity. Under these circumstances, it is therefore necessary to find efficient approaches to synchronization and simpler means for verifying a deterministic behavior.

In contrast to the avionics system data network standards known in the prior art (such as ARINC-664, Part 7, AFDX) or standards still being developed (such as CAIN on TSN), it is necessary to achieve a significantly lower complexity for network components in order to reduce costs, to simplify the network computing capacity used for synchronization, to reduce the time required to achieve safety certification, and to achieve an increase in efficiency.

The invention is therefore based on the object of providing a synchronized data network system and a method for initializing and synchronizing the same, through which a lower complexity of network components, a reduction in costs, a major simplification of the computing capacity required for synchronization, a reduction in the time required for safety certification, and an increase in efficiency can be achieved.

This object is achieved by the synchronized data network system according to claim 1 and by the methods according to claims 13 and 14. Advantageous embodiments and further developments of the invention are set forth in the sub-claims.

In accordance with the invention, a synchronized data network system is provided, which includes a data network that connects data network nodes to one another via direct data transmission links between neighboring data network nodes for an exchange of data. In accordance with the invention, a node chain consisting of successive first, second and third data network nodes is provided among these data network nodes, wherein the second data network node is adapted to receive data transmitted on a first direct data transmission link between the first and the second data network nodes from the first data network node on a data forwarding link and to forward said data in transmit mode to the third data network node on a second direct data transmission link between the second and the third data network nodes. In this process, the second data network node is adapted to delay forwarding of the data on a single-hop data forwarding link between the first and the third data network nodes such that the hop latency is equal to a predetermined fixed common hop latency.

Thus, a synchronized data network system is provided, in which the data network nodes participating in the network are designed such that, when data coming from a transmitter data network node is forwarded to a receiver data network node, an interposed forwarding data network node delays forwarding of the data such that the time period of the hop or the hop latency no longer depends on network-specific or node-specific latencies, but is equalized or leveled for each forwarding node to a fixed hop latency that is equal and common to all.

Although this delay slightly increases the response times or transmission latencies, the data throughput remains the same, and at the same time the synchronization of the entire network is massively simplified, as synchronization data packets, which are usually normal data packets with corresponding header information, from a master data network node can be used to synchronize the slave clocks of the slave data network nodes with the master clock in the easiest possible way, by enlarging the time stamp of the transmitted synchronization packet of the master upon arrival in a slave data network node by the number of hops times the fixed common hop latency.

The synchronization of a data network system described in the following text can also be used in a decentralized data network if several network components have reliable master clocks. Thus, the invention provides a highly redundant method for synchronizing a data network system for deterministic communication among the network participants.

In case of implicit synchronization of the data network system by means of a master data network node that has a master clock, it is preferred when the master data network node transmits synchronization data packets with a master clock time stamp tₜₓ to slave data network nodes and synchronizes the slave clocks of the slave data network nodes with the master clock time in accordance with the completed number of hops h of the synchronization data packet between master data network nodes and respective slave data network nodes, as well as by means of the common hop latency period d_{CH} according to the formula tₘₐₛₜₑᵣ=tₜₓ+d_{CH}*h.

There are two ways of defining a single-hop data forwarding link for leveling to a common hop latency via a single-hop data forwarding link. On one hand, for example, it is possible for the single-hop data forwarding link to correspond to a data forwarding link, which, starting on the transmitter side of the first data network node, passes through the second data network node via the direct data transmission link between the first and the second data network nodes and ends on the transmitter side of the second data network node. On the other hand, it is also possible to define the single-hop data forwarding link such that the single-hop data forwarding link corresponds to a data forwarding link, which, starting on the receiver side of the second data network node, passes through the second data network node and ends, via the direct data transmission link between the second and the third data network nodes, on the receiver side of the third data network node.

For a real implementation of the synchronized data network system, it is advantageous if the second data network node comprises a data transmitting unit that is connected to a direct data transmission link for transmitting data to other data network nodes; a data receiving unit that is connected to a direct data transmission link for receiving data from other data network nodes; a latency matching unit that is adapted to calculate, by means of a stored specific hop latency of the current single-hop data forwarding link and by means of the predetermined fixed common hop latency period, a latency matching period specific to the current single-hop data forwarding link; and a delay buffer that is interposed between the data receiving unit and the data transmitting unit for delaying forwarding of data packets on the current single-hop data forwarding link by the specific latency matching period received from the latency matching unit.

In this process, it is useful if the latency matching unit comprises a timer for measuring a roundtrip latency on a single-hop data forwarding link to be measured; a memory for storing the intrinsic node latency, the roundtrip latencies of the single-hop data forwarding links of the second data network node, as well as the predetermined fixed common hop latency; and a computing unit that is adapted to calculate the latency matching period using the formula d_{ARX}=d_{CH}−d_{RT}/2−d_{SRX_B}.

For a real implementation of initialization and synchronization of the data network system of the invention, it is advantageous if the second data network node comprises a communication control unit for controlling initialization and synchronization, an initialization control unit that controls the initialization process of the data network nodes; and a synchronization control unit that controls synchronization of the data network nodes.

In this process, it is useful if the initialization control unit prompts the second data network node as the slave data network node to perform the steps of: transmitting a roundtrip measurement command from the communication control unit to the data transmitting unit; transmitting, by the data transmitting unit, a roundtrip signal or ping signal to a data receiving unit of a corresponding receiving data network node via a corresponding direct data transmission link of a single-hop data forwarding link to be measured; starting a timer upon transmission of the roundtrip signal by the latency matching unit; receiving, by the data receiving unit, the roundtrip signal sent back from the corresponding data network node via the corresponding direct data transmission link; stopping the timer by the latency matching unit upon receipt of the roundtrip signal sent back; reading the roundtrip latency from the timer; calculating the specific hop latency of the single-hop data forwarding link to be measured by adding the intrinsic node latency to half the roundtrip latency; repeating the steps for all the single-hop data forwarding links to be measured; and storing the ascertained hop latencies of all the single-hop data forwarding links to be measured.

Optionally, if the common hop latency from all the ascertained hop latencies of all the single-hop data forwarding links to be measured is determined by a master data network node during initialization, an additional step of transmitting the ascertained hop latencies of all the single-hop data forwarding links to be measured to the master data network node can take place.

If the second data network node acts as a master data network node, it is advantageous when the initialization control unit prompts the second data network node as the slave data network node to perform the steps of: receiving the respectively ascertained hop latencies of the single-hop data forwarding links of all the slave data network nodes to be measured from the slave data network nodes; and specifying a common hop latency from the transmitted hop latencies, with the predetermined fixed common hop latency being greater than all the transmitted hop latencies.

To ensure that the fixed common hop latency selected is not unnecessarily large, it is useful if the fixed common hop latency corresponds to a time period equal to a hop latency with the longest time period scaled with a safety factor greater than 1 or with a safety offset.

When the data network system is synchronized by the second data network node that acts as a slave data network node, it is advantageous when the synchronization control unit prompts the second data network node as the slave data network node to perform the steps of: receiving, from a master data network node with a master clock, synchronization data packets with a master clock time stamp tₜₓ; and synchronizing the slave clock of the second data network node with the master clock time in accordance with the completed number of hops h of the synchronization data packet between master data network nodes and the second data network node, as well as by means of the common deterministic hop latency period d_{CH} according to the formula tₘₐₛₜₑᵣ=tₜₓ+d_{CH}*h.

If the second data network node acts as a master data network node, it is advantageous when the synchronization control unit prompts the second data network node as the master data network node to transmit, at a time tₜₓ, synchronization data packets with a master clock time stamp tₜₓ to the slave data network nodes.

To make the number of hops with the master clock time stamp available to the slave data network nodes in a simple manner and to ensure that synchronization occurs due to authorized synchronization of the data packet of a master, it is of great advantage if the synchronization data packet includes the number of hops and an identifier of the master data network node in addition to the master clock time stamp.

The synchronized data network system according to the invention has enormous advantages over the prior art when it is used as an avionics system data network for deterministic and/or flight safety-relevant communication between the data network nodes. In this process, it is useful when the data network has a ring, star or network structure with a bidirectional exchange of data.

Furthermore, in accordance with the invention, a method for initializing the synchronized data network system of the invention is provided, including the steps of: transmitting a roundtrip measurement command from a communication control unit of a slave data network node to the data transmitting unit of the slave data network node; transmitting, by the data transmitting unit of the slave data network node, a roundtrip signal or ping signal to a data receiving unit of a corresponding additional slave data network node via a corresponding direct data transmission link of a single-hop data forwarding link to be measured; starting a timer of the slave data network node upon transmission of the roundtrip signal by a latency matching unit of the slave data network node; receiving, by the data receiving unit of the slave data network node, the roundtrip signal sent back from the corresponding additional slave data network node via the corresponding direct data transmission link; stopping the timer by the latency matching unit of the slave data network node upon receipt of the roundtrip signal sent back; reading the roundtrip latency from the timer of the slave data network node; calculating the specific hop latency of the single-hop data forwarding link to be measured by adding the intrinsic node latency to half the roundtrip latency; repeating the steps for all the single-hop data forwarding links to be measured; and storing the ascertained hop latencies of all the single-hop data forwarding links to be measured.

Optionally, if the common hop latency from all the ascertained hop latencies of all the single-hop data forwarding links to be measured is determined by a master data network node during initialization, the following additional steps can be performed: transmitting the ascertained hop latencies of all the single-hop data forwarding links to be measured to the master data network node; receiving, by the master data network node, the respectively ascertained hop latencies of the single-hop data forwarding links of all the slave data network nodes to be measured; specifying, by the master data network node, a common hop latency from the transmitted hop latencies, wherein the predetermined fixed common hop latency is greater than all the transmitted hop latencies.

Furthermore, in accordance with the invention, a method for synchronizing a synchronized data network system of the invention comprising at least one master data network node and slave data network nodes is provided, including the steps of: transmitting, through the master data network node at a time tₜₓ, synchronization data packets with a master clock time stamp tₜₓ to the slave data network nodes; receiving, through the slave data network nodes, synchronization data packets with a master clock time stamp tₜₓ from the master data network node with a master clock, and synchronizing the slave clock of the slave data network node with the master clock time in accordance with the completed number of hops h of the synchronization data packet between master data network nodes and slave data network nodes, as well as by means of the common deterministic hop latency period d_{CH} according to the formula tₘₐₛₜₑᵣ=tₜₓ+d_{CH}*h.

In accordance with the invention, a synchronized data network system, a master data network node and a slave data network node are also provided, which are each adapted to carry out the above methods according to the invention.

The invention will be explained in more detail in the following text by way of example based on the drawings.

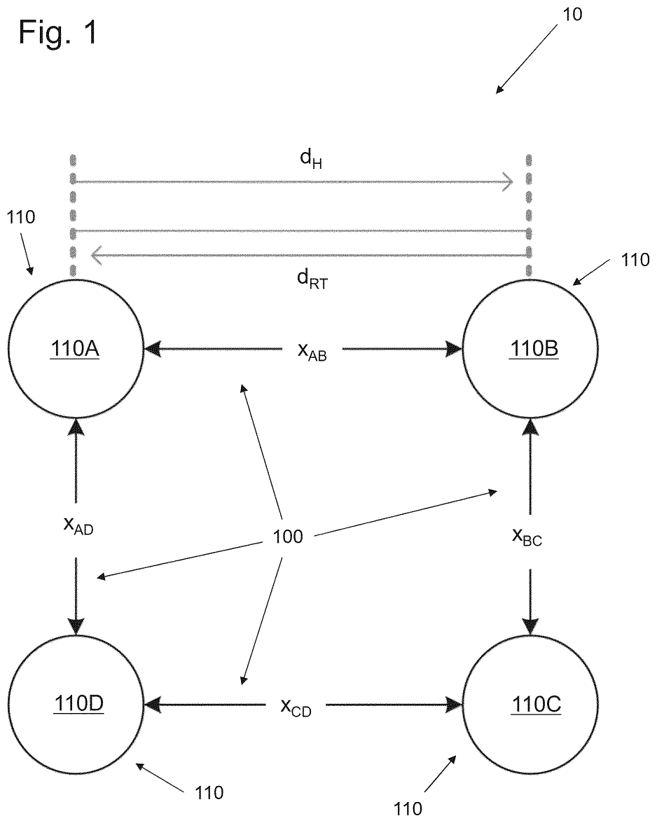

FIG. 1 shows a highly simplified schematic view of a synchronized data network system in a ring structure according to the invention,

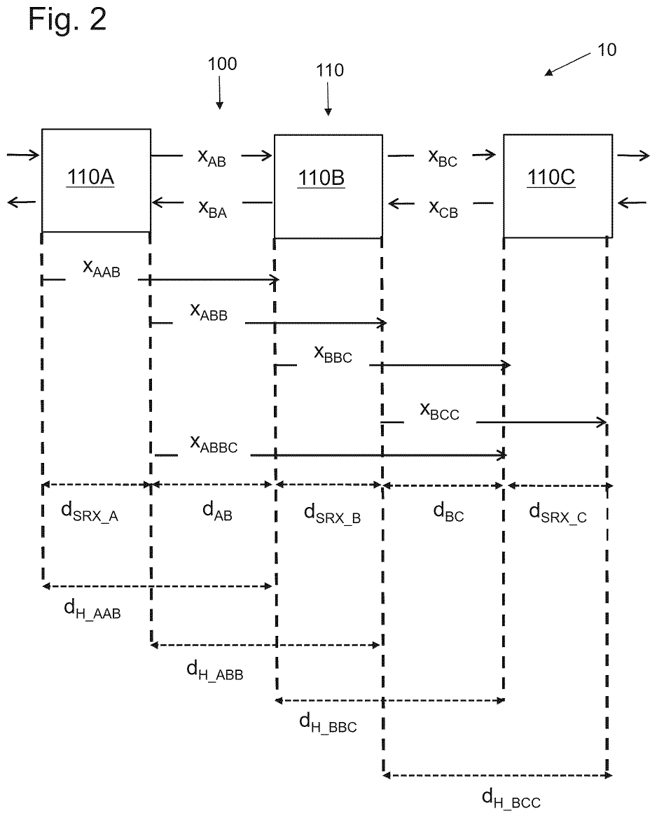

FIG. 2 shows a node chain of first, second and third data network nodes, which are connected to one another by first and second direct data transmission links,

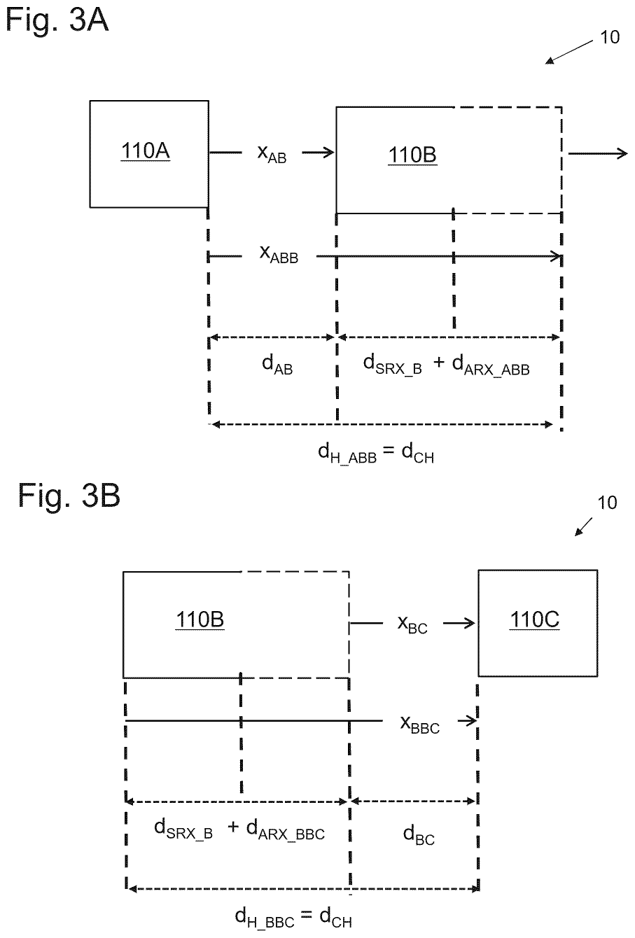

FIG. 3A shows a time flow chart of the delay of forwarding the data through the second data network node according to a first exemplary embodiment of the invention,

FIG. 3B shows a time flow chart of the delay of the data through the second data network node according to a second exemplary embodiment of the invention,

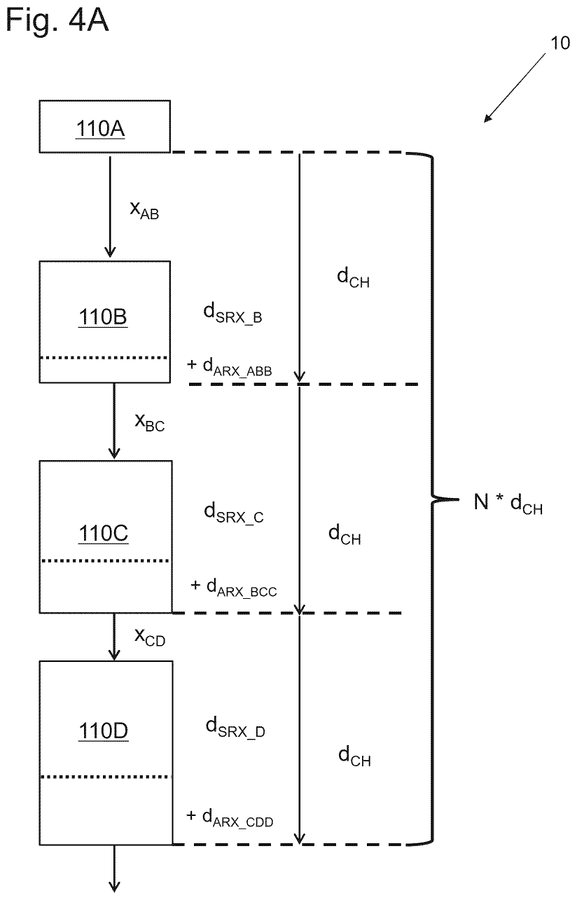

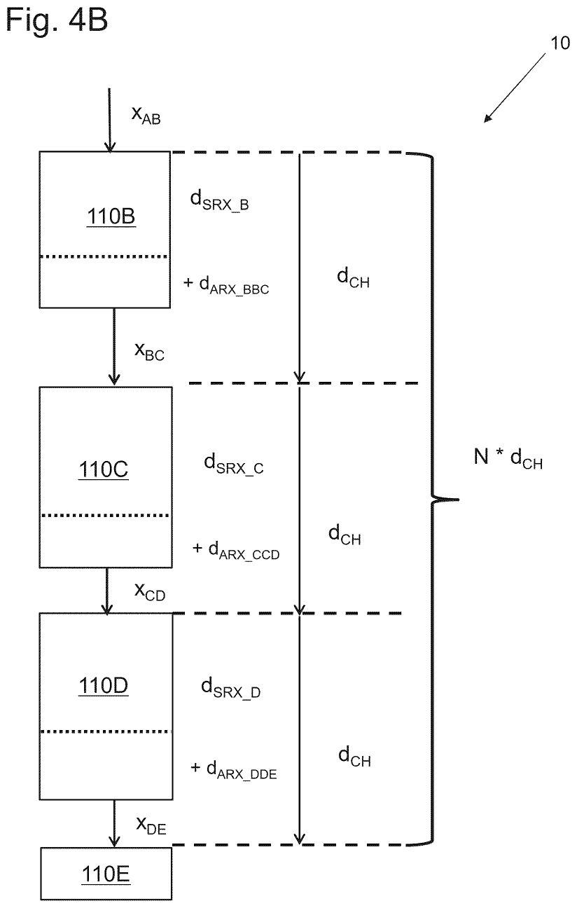

FIG. 4A shows a node chain of first, second, third and fourth data network nodes, which illustrate the delay in data forwarding for the purpose of synchronization according to the first exemplary embodiment of the invention,

FIG. 4B shows a node chain of a second, third, fourth and fifth data network nodes, which illustrates the time flow of the delay in data forwarding for the purpose of synchronization according to the second exemplary embodiment of the invention,

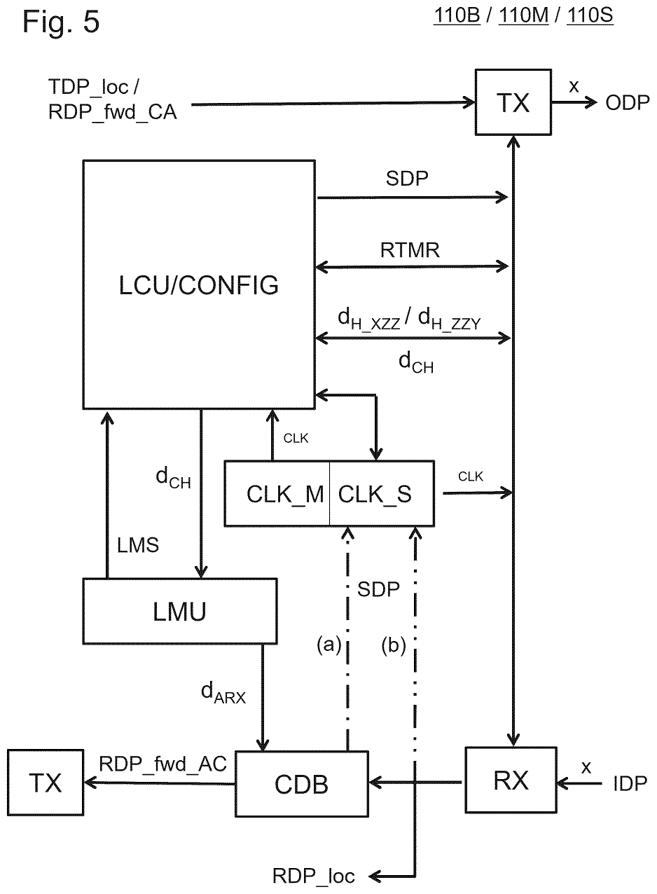

FIG. 5 shows a highly simplified schematic block diagram of a data network node according to the invention,

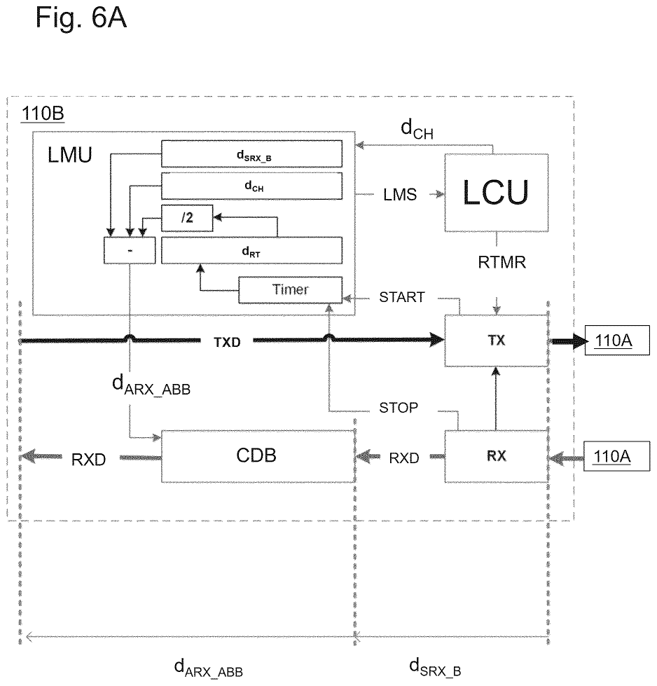

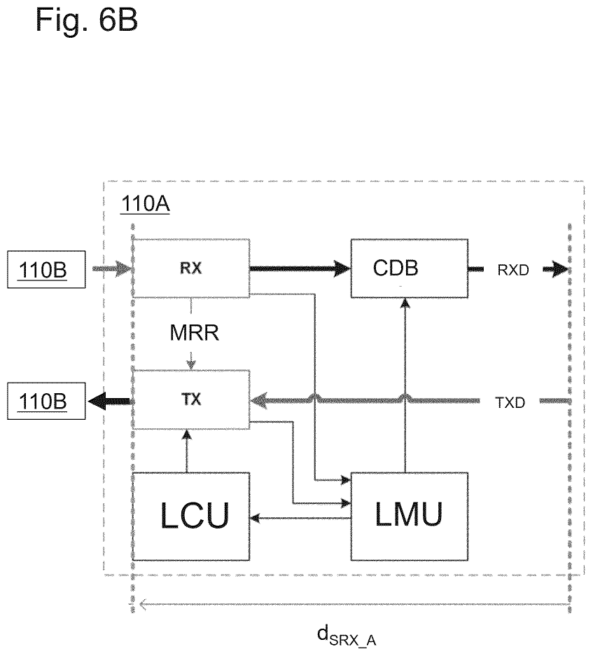

FIGS. 6A and 6B show components of the data network nodes and their role in initialization of the synchronized data network system according to the invention,

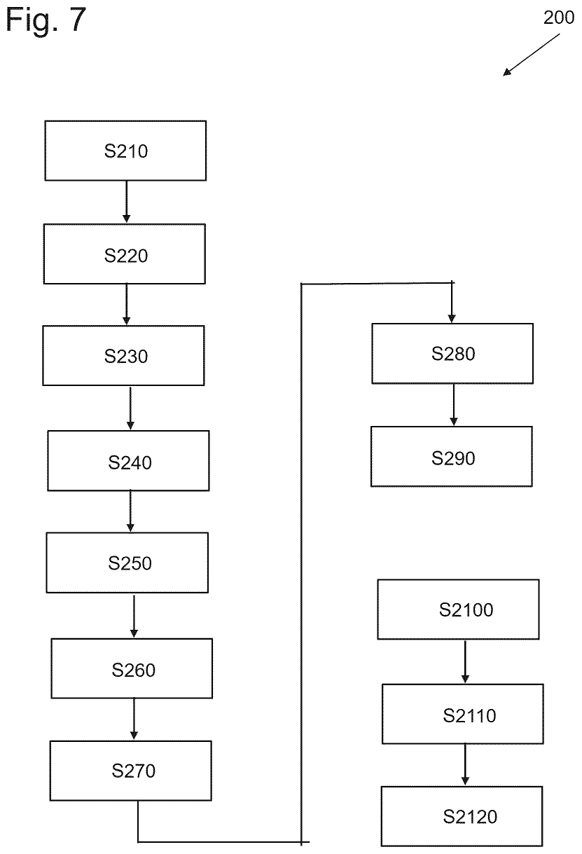

FIG. 7 shows a process flow diagram of the method for initializing the synchronized data network system according to the invention, and

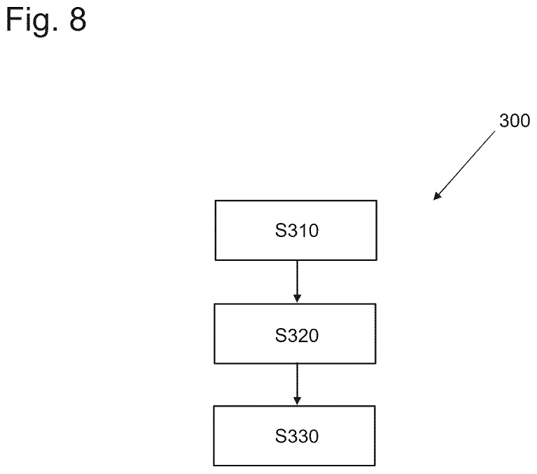

FIG. 8 shows a process flow diagram of a method for synchronizing a synchronized data network system according to the invention.

In the various figures in the drawing, components that correspond to one another are provided with identical reference numerals.

FIG. 1 shows an exemplary embodiment of a synchronized data network system 10 according to the invention. The synchronized data network system 10 includes a data network 100 that connects data network nodes 110 to one another via direct data transmission links x between neighboring data network nodes 110 for the purpose of data exchange. In the depicted exemplary embodiment of the invention according to FIG. 1, the data network nodes 110A, 110B, 110C and 110D are connected to one another in a ring structure via the direct data transmission links X_{AB}, X_{BC}, X_{CD}, X_{AD}. Although the data network system 10 in FIG. 1 has a ring structure, it is, nevertheless, also possible to provide a data network 100 as the data network system 10, which has a star or network structure. The invention can be introduced onto any network topology and is therefore not limited to a specific network structure. The topology of the network structure is therefore free; the only requirement is the bidirectionality of the connections between the nodes and that at least one node must have more than one interface to neighboring nodes in order to be able to generate a topology with more than two participants. The number of data network nodes 110 is also arbitrary; the four data network nodes 110A, 110B, 110C and 110D depicted in FIG. 1 are to be understood purely as an example.

Prefabricated avionics components are preferably provided as data network nodes 110 in the data network system 10 in order to provide an avionics system data network via which deterministic and potentially flight safety-relevant communication between the avionics components as data network nodes is enabled. Such deterministic communication is particularly essential in flight networks or when using autonomous flight or driving applications, as synchronized communication and traceability of causal chains in an avionics system are required, in particular, for proof of flight safety and, of course, for flight safety itself. These systems are used when the preservation of human life, the fulfillment of a military mission, or the transport of high material assets is at stake. As avionics components that are used as data network nodes 110 in the sense of the invention, a variety of avionics components are conceivable, such as computer systems for flight control or mission management, human-machine interfaces such as display or input devices, flight attitude sensors, engine sensors and actuators, tail sensors and actuation or weapon systems in which weapons can be triggered or decoys launched via the synchronized data network system. Although use in avionics is particularly preferred, the use of the synchronized data network system according to the invention is not to be limited to this, but, for example, can be used in the field of nautics, aerospace such as in satellite systems or in safety-relevant large plants.

In the data network system 10 according to the invention, the direct data transmission link x between two data network nodes 110 can enable bidirectional or dual simplex communication. The temporal behavior of data sent through the network 100 is mainly characterized by a unidirectional hop latency d_{H} and a combined roundtrip latency d_{RT}, which depends for each link on external factors such as the physical medium or environmental conditions and internal factors such as the design or implementation of the data network node 110.

Due to the variation in hop latencies du across the data network system 10, the runtime for the transmission of data packets from a source data network node 110 to an end receiver data network node 110 is not a direct function of the data forwarding link selected by the data network 100 and the number of hops on this data forwarding link. Rather, it is necessary that all specific latencies caused by external or internal factors of the network are taken into account, which means an enormous computational effort if one wants to implicitly synchronize the data network system 10. In this case, implicit synchronization means synchronization of all the network node slave clocks to a master clock of a master data network node 110M (FIG. 5) by transmitting synchronization data packets from the master data network node 110M to the data network nodes 110.

Furthermore, such synchronization is not only computationally intensive, but also depends on runtime initialization and thus also has an influence on the determinism of the system, as it requires tolerances over the entire runtime-Dependent value range.

In FIG. 2, the synchronized data network system 10 according to the invention is depicted in even further detail, with the various latencies generated either by the data network nodes 110 or by the direct data transmission links x being discussed in more detail herein. FIG. 2 shows a node chain of the data network nodes 110 according to the invention consisting of successive first, second and third data network nodes 110A, 110B and 110C, which are connected to one another via direct data transmission links X_{AB} and X_{BC} during transmission of data from the data network node 110A to the data network node 110C. Bidirectional communication is also possible via the direct transmission links X_{CB} and X_{BA}, however, for reasons of simplicity, only the forwarding direction from the nodes 110A to 110C is to be taken into account.

In accordance with the invention, the second data network node 110B is adapted to receive data transmitted on the first direct data transmission link X_{AB} between the first and the second data network nodes 110A, 110B from the first data network node 110A on a data forwarding link X_{ABBC} and to forward said data to the third data network node 110C on a second direct data transmission link X_{BC} between the second and the third data network nodes 110B, 110C.

In accordance with the invention, a distinction is therefore to be made between the direct data transmission link x that is part of the data network 100, and a data forwarding link X_{ABBC}, which also comprises the transmission link through a data network node 110 with a corresponding intrinsic node latency.

In particular, the single-hop data forwarding links X_{AAB}, X_{ABB}, X_{BBC}, X_{BCC} or in the following also generally referred to as X_{XZZ} or X_{ZZY} are of interest for the invention, since it is the smallest unit of a data forwarding hop from one data network node 110 to another data network node 110. There are two possible approaches for defining a single-hop data forwarding link:
(a) The single-hop data forwarding link can be defined such that it corresponds to the data forwarding links X_{ABB} and X_{BCC}. Thus, the direct data transmission link X_{AB} from the transmitter data network node 110A to the forwarding data network node 110B and the data forwarding link through the data network node 110B are combined in this case as a single-hop data forwarding link. In the case where the data network node 110C is the forwarding data network node 110, the direct data transmission link X_{BC} and the data forwarding link through the data network node 110C are combined as the single-hop data forwarding link X_{BBC}. Thus, in the case where the second data network node 110B is the forwarding data network node 110, the single-hop data forwarding link corresponds to a data forwarding link X_{ABB}, which, starting on the transmitter side of the first data network node 110A, passes through the second data network node 110B via the direct data transmission link X_{AB} between the first and the second data network nodes 110A, 110B and ends on the transmitter side of the second data network node 110B.
(b) According to a second exemplary embodiment, the single-hop data forwarding link X_{AAB}, X_{BBC} consists of the forwarding link with a corresponding latency of the forwarding node 110 and the subsequent direct data transmission link X_{AB}, X_{BC}, via which the data, originating from the forwarding data network node 110A, 110B, is transmitted to a corresponding additional data network node 110B, 110C. This, therefore, means that, in case that the second data network node 110B is the data forwarding data network node, the single-hop data forwarding link corresponds to the data forwarding link X_{BBC}, which, starting on the receiver side of the second data network node 110B, passes through the second data network node 110B and ends, via the direct data transmission link X_{BC} between the second and the third data network nodes 110B, 110C, on the receiver side of the third data network node 110C.

As can further be seen in FIG. 2, corresponding latencies are assigned to the corresponding forwarding links through the data network nodes 110 and through the direct data transmission links x, which latencies relate either to the runtime or latency d_{SRX_A}, d_{SRX_B}, d_{SRX_C} when data is forwarded through the data network node 110 or to the runtime or latency when data is forwarded via the direct data transmission links X_{AB} and X_{BC} with latencies d_{AB} and d_{BC}.

With regard to the single-hop data forwarding links, the hop latencies d_{H_AAB}, d_{H_ABB}, d_{H_BBC} and d_{H_BCC} result accordingly from the sum of the intrinsic node latency d_{SRX} and the transmission latency via the direct data forwarding links x. Although the hop latencies in FIG. 2 are all depicted as having the same size, the problem with a known data network system 10 immediately arises that the variance in the intrinsic node latencies and transmission latencies makes implicit synchronization of the data network system 10 very complex.

This problem, however, is overcome by the synchronized data network system 10 according to the invention, as, for example, illustrated in FIGS. 3A and 3B. FIG. 3A shows a detailed view from FIG. 2, where a delay in data forwarding according to a first exemplary embodiment takes place therein, with the section of FIG. 2 depicted in FIG. 3B representing a delay in data forwarding according to the second exemplary embodiment of the invention.

As depicted in FIG. 3A, the second data network node 110B is adapted to delay forwarding of the data on a single-hop data forwarding link X_{ABB} between the first and the third data network nodes 110A, 110C such that the hop latency d_{H_ABB} is equal to a predetermined fixed common hop latency d_{CH}. In this process, the single-hop data forwarding link corresponds to a data forwarding link X_{ABB} which, starting on the transmitter side of the first data network node 110A, passes through the second data network node 110B via the direct data transmission link X_{AB} between the first and the second data network nodes 110A, 110B and ends on the transmitter side of the second data network node 110B.

In FIG. 3B, the second data network node 110B is adpated to delay forwarding of the data on a single-hop data forwarding link X_{BBC} between the first and the third data network nodes 110A, 110C such that the hop latency d_{H_BBC} is equal to a predetermined fixed common hop latency d_{CH}. In this process, the single-hop data forwarding link corresponds to a data forwarding link X_{BBC}, which, starting on the receiver side of the second data network node 110B, passes through the second data network node 110B and ends, via the direct data transmission link X_{BC} between the second and the third data network nodes 110B, 110C, on the receiver side of the third data network node 110C.

Even if both exemplary embodiments (a) (FIG. 3A) and (b) (FIG. 3B) are discussed for the sake of completeness, the first exemplary embodiment (a) is preferred, since a real implementation of the second exemplary embodiment (b) is somewhat more difficult. In particular, in the second exemplary embodiment in FIG. 3B, outgoing locally generated packets must be generated in the RX path of the second data network node 110B, time-stamped and delayed towards the transmission link TX of the second data network node 110B. This also delays any data transfers between neighboring nodes 110 that would not have to be delayed (see also paths IDP->RDP_loc and IDP->RDP_fwd_AC in FIG. 5).

In accordance with the invention, the intrinsic node latency d_{SRX_B} is thus extended by a variable node latency d_{AX_ABB} or d_{AX_BBC} by means of a delay circuit in a forwarding data network node 110 such that, irrespective of the data transmission link latencies d_{AB} or d_{BC} and irrespective of the intrinsic node latency d_{SRX_B} in a forwarding hop through the second data network node 110B, the forwarding runtime or the forwarding latency or the single-hop data forwarding latency d_{H_ABB} or d_{H_BBC} is always equal to a predetermined common hop latency d_{CH}, no matter which data network node 110 or which associated direct data transmission link x of a selected single-hop data forwarding link is selected in the synchronized data network system 10 according to the invention.

Although the delay circuit in the second network node 110B and all other forwarding data network nodes 110 delays data transmission in the data network system 10 according to the invention, this approach extremely simplifies synchronization of the entire data network system 10. This is illustrated in FIG. 4A for the first exemplary embodiment of the invention and in FIG. 4B for the second exemplary embodiment of the invention.

Thus, synchronization of the data network system 10 according to the invention can, for example, be achieved by using a master data network node 110M (FIG. 5) to synchronize corresponding slave data network nodes 110S of the data network system 10 with a master clock CLK_M (FIG. 5). For this purpose, the master data network node 110M is adapted to transmit synchronization data packets SDP with a master clock time stamp tₜₓ to slave data network nodes 110S at periodic intervals or on instruction by a user and to synchronize the slave clocks CLK_S of the slave data network nodes 110S with the master clock time of the master data network node 110M in accordance with the completed number of hops h of the synchronization data packet SDP between master data network nodes 110M and respective slave data network nodes 110S, as well as by means of the common hop latency period d_{CH} according to the formula tₘₐₛₜₑᵣ=tₜₓ+d_{CH}*h.

Synchronization with this above simple formula is made possible by the fact that, as depicted in FIGS. 4A and 4B, forwarding of a synchronization data packet SDP from the data network nodes 110A to 110D (FIG. 4A) or from the data network nodes 110B to 110E (FIG. 4B) has a clearly defined time period from the master data network node 110M to a slave data network node 110S to be synchronized, namely the number of hops from the master data network node 110M to the respective slave data network node 110S times the predetermined fixed common hop latency d_{CH}. The data transmission links X_{AB}, X_{BC}, X_{CD}, X_{DE} can be of various natures, where, in addition to a wired or cabled connection or a fiber optic connection, for example, a cable-free or wireless radio connection for a direct data transmission link x is also possible. Furthermore, the intrinsic node latencies d_{SRX} can also be different, since a hop latency is always adjusted or leveled to a predetermined common fixed hop latency d_{CH} during data forwarding, irrespective of the selection of the data network node 110.

It is emphasized that although synchronization of the data network system 10 according to the invention by means of a master data network node 110M is preferred, synchronization can also occur in a decentralized data network system if several network nodes are equipped with clocks suitable as master clocks. For example, it is also conceivable that not only one master data network node 110M is provided, but that a plurality of data network nodes 110 or even all of the data network nodes 110 can operate as a master data network node 110M, whereby the failure safety and redundancy of the synchronized data network system 10 according to the invention are maximized. In this case, only a corresponding coordination between the data network nodes 110 needs to take place so that no two data network nodes 110 perform the master role at the same time.

By means of the synchronization method according to the invention, it is therefore possible to achieve synchronization of all the data network nodes in a simple manner by means of a hop latency that is the same for all the data network nodes and corresponding forwarding links and is common for all connections in a closed network.

In FIG. 5, a block diagram of a data network node 110 according to the invention is depicted. In this case, for example, the second data network node 110B comprises a data transmitting unit TX, which is connected to a direct data transmission link x for transmitting data ODP to other data network nodes 110, which are either locally generated data packets TDP_loc to be transmitted or forwarded data packets RDP_fwd to be transmitted. The second data network node 110B further comprises a data receiving unit RX, which is connected to a direct data transmission link x to receive data IDP from other data network nodes 110. As depicted in FIG. 5, the second data network node 110B further includes a latency matching unit LMU which is adapted to calculate, by means of a stored specific hop latency d_{H_ABB}, d_{H_BBC} of the current single-hop data forwarding link X_{ABB}, X_{BBC} and by means of the predetermined fixed common hop latency period d_{CH}, a latency matching period d_{ARX} specific to the current single-hop data forwarding link X_{ABB}, X_{BBC}. In case of forwarding data packets IDP from the data receiving unit RX via the data transmitting unit TX to other data network nodes 110, the data packet RDP_fwd (e.g., RDP_fwd_AC or RDP_fwd_CA) passes through a delay buffer CDB interposed between the data receiving unit RX and a data transmitting unit TX designated for forwarding in order to delay forwarding of data packets RDP_fwd_AC on the current single-hop data forwarding link X_{ABB}, X_{BBC} by the specific latency matching period d_{ARX} received from the data latency matching unit LMU.

The structure of the latency matching unit LMU is depicted in FIG. 6A. The LMU has a timer for measuring a roundtrip latency d_{RT} on a single-hop data forwarding link X_{ABB}, X_{BBC} to be measured and a memory for storing the intrinsic node latency d_{SRX_B}, the roundtrip latencies d_{RT} of the single-hop data forwarding links X_{ABB}, X_{BBC} of the second data network node 110B and the predetermined fixed common hop latency d_{CH}. Furthermore, the latency matching unit LMU has a calculation unit which is adapted to calculate the latency matching period d_{ARX_ABB} specific to a single-hop data forwarding link using the formula d_{ARX}=d_{CH}−d_{RT}/2−d_{SRX_B}.

As depicted in FIG. 5, a delay of the data packets only takes place if they are designated for forwarding, while, on the other hand, received data packets RDP_loc which are no synchronization data packets and are designated for local further processing in the corresponding second data network node 110B are not delayed. Thus, the configurable delay of data forwarding is preferably provided on the receiver side of each node according to the first exemplary embodiment, exclusively for packets which have not reached their destination address and which are forwarded to the data transmitting unit TX for forwarding from the data receiving unit to the data transmitting unit. In this way, packets which are further processed locally can be sent promptly and directly to the end user without further delay, in contrast to an implementation according to the second exemplary embodiment of the invention, in which a delay occurs on the transmitter side for the forwarding link to be covered until the next data network node 110.

As further depicted in FIG. 5, the second data network node 110B has either a master clock CLK_M or a slave clock CLK_S, depending on whether the second data network node 110B operates as the master data network node 110M or the slave data network node 110S. In the case where the second data network node 110B operates as the slave data network node 110S, the slave clock CLK_S is synchronized with the master clock CLK_M of another master data network node 110M by a synchronization data packet SDP either without delay following receipt according to the second exemplary embodiment or after a delay by the delay buffers CDB according to the first exemplary embodiment. The second data network node 110B further includes a communication control unit LCU/CONFIG for controlling initialization and synchronization, wherein the communication control unit LCU/CONFIG comprises an initialization control unit LCU that controls the initialization process of the data network nodes 110 and a synchronization control unit CONFIG that controls synchronization of the data network nodes 110.

In the following text, an initialization process of the synchronized data network system according to the invention and subsequently a synchronization process of the data network 10 according to the invention will be described.

During network initialization, all nodes in the network are prompted to independently determine the latencies on all the data transmission links to their neighboring nodes in the network. In this process, the data network node interface implementation must be symmetrical or have a known asymmetry that is taken into account by the neighboring nodes. Thus, the hop latency can be correctly derived from a roundtrip latency measurement. Before initialization of the network is completed, each individual node is then prompted to insert an additional delay or a specific latency matching period d_{ARX} into the data receiving path associated with all the data transmission links and connections to the neighboring node, so that the resulting hop latency on all these connection links corresponds to a configurable common value for the entire network, this value being determined from all the single-hop data forwarding latencies before the network is commissioned. This value is the predetermined fixed common hop latency d_{CH} or the common deterministic hop latency d_{CH}.

At this point, it should be emphasized that initialization of the network is completely decentralized and the distinction between slave data network nodes 110S and master data network nodes 110M is initially irrelevant, since the subsequent master data network node 110M as the slave data network node 110S also initially undergoes the same initialization process as all the other data network nodes 110. This means that all the nodes determine the roundtrip latency to their neighbors as part of the network initialization (generating requests, receiving responses, as well as receiving requests and generating responses). There are no roles here, and all nodes are equal. As soon as each node has determined the necessary information, the target latency is set and the initialization phase ends. The uniform hop latency then enables implicit time synchronization simply because the defined master communicates regularly with all the other nodes (unidirectional, no response required).

In detail, from the perspective of the second data network node 110B in its role as the slave data network node 110S, the initialization proceeds as follows in an exemplary probing of the single-hop data forwarding link to its neighboring node 110A, as illustrated in FIGS. 6A and 6B.

Thus, the initialization control unit LCU prompts the second data network node 110B as the slave data network node 110S to perform the following steps during an initialization process of the synchronized data network system 10. First, a roundtrip measurement request RTMR is sent from the communication control unit LCU to the data transmitting unit TX. Then, the data transmitting unit TX transmits a roundtrip signal or a ping signal to a data receiving unit RX of a corresponding receiving data network node 110A via a corresponding direct data transmission link x, in this case X_{AB}, of the exemplary single-hop data forwarding link X_{ABB} to be measured in case of an implementation of the first exemplary embodiment of the invention. When the roundtrip signal is transmitted, the timer of the latency matching unit LMU is simultaneously started by the latency matching unit LMU. The roundtrip signal or ping signal transmitted to the data network node 110A is received by the data receiving unit RX of the data network node 110A and is sent back again directly to the receiving unit RX of the second data network node 110B by means of a measurement request response MRR (FIG. 6B) via the data transmitting unit TX of the data network node 110A. As soon as the data receiving unit RX has received the roundtrip signal sent back from the corresponding first data network node 110A via the corresponding direct data transmission link X_{AB}, the timer is stopped by the latency matching unit LMU upon receipt of this roundtrip signal sent back.

After reading the roundtrip latency d_{RT} from the timer of the latency matching unit LMU, the latency matching unit LMU calculates the specific hop latency d_{H_ABB} of the single-hop data forwarding link X_{ABB} to be measured in the example of FIG. 6A and FIG. 6B by adding the intrinsic node latency d_{SRX_B} to half the roundtrip latency d_{RT}. The intrinsic node latency d_{SRX_B} can be ascertained by the second data network node 110B itself by internally measuring an internal forwarding latency of data packets from the data receiving unit RX to the data transmitting unit TX. This intrinsic node latency value can also be measured when the participating data network node is established and stored or saved in the memory of the latency matching unit LMU.

Since the second data network node 110B must measure any and all single-hop data forwarding links X_{XBB}, X_{BBY} according to the first or second exemplary embodiment for complete initialization of the initialized data network system 10, the initialization process described above is repeated until the second data network node 110B has measured any and all single-hop data forwarding links to data network nodes 110 directly connected to it.

In case that a “worst case” hop latency is already ascertained during the verification phase of the platform, this is then made known as a predetermined common hop latency d_{CH} to each data network node 110 as a configuration.

However, it is also possible for the network to dynamically ascertain the common hop latency d_{CH} itself in order to optimize the overall latency. In this case, this can, for example, be done via a master data network node 110M, but an external reader can also be used that is connected once to the network during initialization in order to read out all the ascertained hop latencies d_{H_XZZ}, d_{H_ZZY} of all the single-hop data forwarding links X_{XZZ}, X_{ZZY} of all the data network nodes 110 to be measured.

In principle, however, there is no exchange of the ascertained hop latencies between the nodes and there are no master/slave roles in this respect. Each node is solely responsible for determining the roundtrip latency to the neighboring node and calculating the necessary delay therefrom to adapt, in terms of time, the forwarding paths through the local node to a target latency established in the system in advance.

Following the complete measurement of all the single-hop data forwarding links and the associated hop latencies d_{H_XBB}, d_{H_BBY} of all the single-hop data forwarding links X_{XBB}, X_{BBY} to be measured, the ascertained hop latencies can be transmitted to the master data network node 110M in case that the master data network node 110M is designated for determining the common hop latency d_{CH}.

Thus, in case that the second data network node 110B operates as such a master data network node 110M, the initialization unit LCU prompts the second data network node 110B as the master data network node 110M to perform the following steps. Thus, the second data network node 100B receives, from the slave data network nodes 110S, the respectively ascertained hop latencies d_{H_XZZ}, d_{H_ZZY} of the single-hop data forwarding links X_{XZZ}, X_{ZZY} of all the slave data network nodes 110S to be measured. Since the master data network node 110M is aware of any and all hop latencies of all the single-hop data forwarding links of all the slave data network nodes to be measured, the master data network node 110M specifies a common hop latency d_{CH} from the hop latencies transmitted. The master data network node 110M is relatively free in the type of specification; the only condition that applies is that the predetermined fixed common hop latency d_{CH} is equal to the largest or greater than all the transmitted hop latencies d_{H_XZZ}, d_{H_ZZY}, since otherwise at least one transmitted hop latency would be greater than the fixed common hop latency d_{CH} and thus synchronization in the sense of the invention would not be possible.

In addition to the fact that the common hop latency d_{CH} must be greater than all the hop latencies of all the single-hop data forwarding links in the network 10, it is further advantageous if the difference in time period between the specified common hop latency d_{CH} and the hop latencies with the longest time period transmitted by the slave data network node 110S is chosen to be as small as possible in order not to unnecessarily delay the data traffic within the synchronized data network system 10 by an unnecessarily large common hop latency d_{CH}. Thus, a typical hop latency period in an avionics data network system 10 according to the invention is in the range of 350 ns, where, for example, a specified common hop latency d_{CH} of 500 ns would be an acceptable value for the common hop latency. It should be emphasized that the figures mentioned are only orders of magnitude, since only a small part of the latency is caused by cable lengths. The majority of latencies is introduced by the transceivers and through implementation of the network interface of the nodes.

In a practical implementation of the ascertainment of the fixed common hop latency d_{CH}, the fixed common hop latency d_{CH} can therefore correspond to a time period that is equal to a hop latency d_{H_XZZ}, d_{H_ZZY} with the longest time period scaled with a safety factor greater than 1 or with a safety offset. For example, the safety factor can correspond to a value greater than 1 and less than 1.5, less than 1.4, less than 1.3, less than 1.2 or less than 1.1, or less than 1.05. The safety offset can lie in a range between 100 ns and 200 ns. It should be noted at this point that the cable lengths, as described above, only account for a small proportion of the overall latency for data transmission in the network 10 on the data transmission links x. The required range depends on the runtime variations (minimum) and the resources used for delay buffers (maximum). In any case, the additive latency is usually low compared to the latencies that have already incurred due to transceivers and cable lengths. It is important to note that the cable length has much less influence on short transmission links (e.g., less than 10m) than the structure of the interface and the transceivers in the nodes themselves. In a prototype implementation, total latencies of approx. 300 ns were measured for a transmission link with 3m connection cables, of which approx. 5 ns/m are attributable to the optical fiber.

In any case, the offset should be dimensioned such that the system does not have to be completely reconfigured and initialized again if the system is modified or if an additional cable section of 10 cm to 50 cm is inserted. The larger the offset selected, the more robust the data network system 10 is in the event of a change in components with regard to their latencies. It should also be emphasized here that discrete values make little sense in this case. The larger the safety offset, the greater changes in length are possible, provided that the runtime variation is known.

The safety offset therefore only specifies the maximum compensation possibility, but this does not mean that this must always be exhausted. Rather, it depends on the target network. Even in a system that can variably add node delays of up to 1 s, it is still possible to work with a maximum offset of 5 ns, as all the nodes have a very low delay that is so determined before commissioning and is then, naturally, also set as the target latency. It should not be possible to dynamically optimize a network after the system has changed, for example. If there are any changes in the system, then the common target latency must be ascertained anew and transmitted to all the nodes.

After, as depicted in FIG. 5, the second data network node 110B as the master data network node 110M has received any and all hop latencies d_{H_XZZ}, d_{H_ZZY} of the single-hop forwarding links of all the slave data network nodes 110S to be measured and has determined a common hop latency d_{CH}, the specified common hop latency d_{CH} is transmitted to all the slave data network nodes 110S, which then store the value d_{CH} in a memory of the latency matching unit LMU, after it has been transmitted to them by the communication control unit LCU/CONFIG.

Since the latency matching unit LMU has now stored any and all important latencies in the forwarding of data packets, namely the intrinsic node latency d_{SRX_B}, the common hop latency d_{CH} and for each relevant single-hop forwarding link in which the second data network node 110B can be involved, the latency matching unit LMU can now, depending on the data forwarding link, calculate a corresponding matching period d_{ARX} specific to the single-hop data forwarding link and transmit it to the delay buffer CDB, which then delays data packets RDP_fwd accordingly. In this process, the delay buffer CDB can be a normal FIFO buffer (first-in-first-out buffer), which buffers data briefly and reads it out again and forwards it after a predetermined delay period. In addition, the latency matching unit LMU is in a data connection with the communication control unit LCU/CONFIG in order to communicate its latency matching status LMS to the LCU/CONFIG.

In the following text, a synchronization process of the synchronized data network system 10 according to the invention is to be described.

Since, after the initialization process, the data forwarding latency on arbitrary routes through the network is now an integer multiple of the specified common deterministic hop latency d_{CH}, this situation can be exploited to perform an extremely simplified synchronization procedure of the local time of all the nodes in the network with a local time of a specific master node with a master clock CLK_M. In this process, synchronization occurs implicitly by a periodic transmission of packets from the timing master node to all the other nodes, selecting arbitrary routes through the network. These packets can carry a time stamp that reflects the local time at the timing master node that is immediately current at the start of the transmission (time stamp tₜₓ). In addition, these data packets or synchronization data packets SDP can include a unique identifier of the timing master node as the sender address (node ID) and can, moreover, indicate how many hops (#hop) have been performed on the current route through the network to the node that is currently receiving the packet.

Based on the synchronization data packets SDP transmitted by the timing master node, the current local time at the timing master node when such a synchronization data packet arrives at the node is equal to the time stamp tₜₓ included in the synchronization data packet SDP plus the number of hops h times the specified common deterministic hop latency d_{CH}:
Tₘₐₛₜₑᵣ=tₜₓ+d_{CH}*h.

This method according to the invention is an implicit synchronization method, where no specific protocol needs to be implemented in order to implement the time between a timing master and a slave node in a network, since synchronization can occur implicitly for any type of communication between the timing master and the slave node if it takes place at periodic intervals or recurrently within a certain time window. For example, the data packet SDP can be dedicated to synchronization of the entire data network on one hand, but it is also conceivable that the synchronization data packet information containing the time stamp, the number of hops and the node ID of the master data network node 110M is inserted into the header at periodic intervals or recurrently within a specific time window for normal data packets to corresponding slave data network nodes 110S. The repetition period of periodic transmission of the synchronization data packet SDP can be selected in accordance with the accuracy requirements, the drift of the slave clocks over time and other factors.

Dedicated synchronization data packets are therefore only required if there is no regular or recurring communication between the timing master and the other nodes in the network within a certain time window anyway. Synchronization occurs implicitly via arbitrary data packets, as the information required for synchronization is embedded in each packet header. Of course, these fields are only relevant if the source node corresponds to the timing master. A synchronization data packet SDP is then nothing more than a normal packet, which does not necessarily have to transport data.

Each node uses the currently valid local time as the TX time stamp tₜₓ for all packets that it generates. This is not affected in case of forwarding by subsequent nodes, only the hop count h is increased. Each node is potentially capable of taking on the role of the timing master. This is configured firmly in advance without any particular effect on the transmission behavior of the nodes. Only during reception it is important that synchronization information is only taken from packets that originate from the timing master (TX ID=master). This greatly abstracts the process of time synchronization and no special control is required, apart from specifying the roles in advance and ensuring that the application layer schedules network traffic between the timing master and all other nodes at regular intervals, which then implicitly ensures time synchronization in the network. Synchronization information comprises the combination of TX time stamp tₜₓ, hop count h, and the TX ID, all of which can be transported as part of the packet header (fields), for example, as well as the common deterministic hop latency period d_{CH} stored locally at each node. In detail, the synchronization control unit CONFIG prompts the second data network node 110B, if it is operating as a slave data network node 110S, to perform the following steps.

Thus, it receives synchronization data packets SDP with a master clock time stamp tₜₓ from a master data network node 110M with the master clock CLK_M. Then, as depicted in FIG. 5, after the synchronization data packet has been received by the data receiving unit RX, either a delay of the synchronization data packet SDP (path (a) in FIG. 5) occurs when the single-hop data forwarding link is defined according to the first exemplary embodiment or as depicted in FIG. 3A or 4A. In case that the single-hop forwarding link is defined according to the second exemplary embodiment, i.e., as depicted in FIGS. 3B and 4B, no delay by the delay buffers CDB need occur (path (b) in FIG. 5), since the specific latency matching period dARx has already been added up by the preceding transmitting data network node 110 for the input transmission link x. The slave clock CLK_S of the second data network node 110B or 110S is then synchronized by means of control by the communication control unit LCU/CONFIG. The slave clock CLK_S of the second data network node 110B is thus synchronized with the master clock time in accordance with the completed number of hops h of the synchronization data packet SDP between master data network nodes 110M and the second data network node 110B, as well as by means of the common deterministic hop latency period d_{CH} according to the formula tₘₐₛₜₑᵣ=tₜₓ+d_{CH}*h.

In case that the second data network node 110B operates as the master data network node 110M, the synchronization control unit CONFIG prompts it to perform the following steps. Thus, the synchronization control unit CONFIG ensures that, at a time tₜₓ, synchronization data packets SDP with a master clock time stamp tₜₓ are transmitted to the slave data network nodes 110S, whereas the synchronization data packet SDP can include the number of hops h and an identifier ID_M of the master data network node 110M in addition to the master clock time stamp tₜₓ.

In accordance with the invention, a method for initializing a synchronized data network system 10 is also provided that includes the following steps, as depicted in FIG. 7. Thus, in step S210, a roundtrip measurement command RTMR is transmitted from a communication control unit LCU of a slave data network node 110S to the data transmitting unit TX of the slave data network node 110S. In step S220, the data transmitting unit TX of the slave data network node 110S transmits a roundtrip signal or ping signal to a data receiving unit RX of a corresponding additional slave data network node 110S via a corresponding direct data transmission link x of a single-hop data forwarding link X_{XBB}, X_{BBY} to be measured.

In this process, in step S230, a timer of the slave data network node 110S is started upon transmission of the roundtrip signal by a latency matching unit LMU of the slave data network node 110S. After receiving (step S240) the roundtrip signal sent back from the corresponding additional slave data network node 110S by the data receiving unit RX of the slave data network node 110S via the corresponding direct data transmission link x, the timer is stopped, in step S250, by the latency matching unit LMU of the slave data network node 110S upon receipt of the roundtrip signal sent back. In step S260, the roundtrip latency d_{RT} is read from the timer of the slave data network node 110S, and, in step S270, the specific hop latency d_{H_XBB}, d_{H_BBY} of the single-hop data forwarding link X_{XBB}, X_{BBY} to be measured is calculated by adding the intrinsic node latency d_{SRX_B} to half the roundtrip latency d_{RT}. After repeating the steps (S280) for all the single-hop data forwarding links X_{XBB}, X_{BBY} to be measured, the ascertained hop latencies d_{H_XBB}, d_{H_BBY} of all the single-hop data forwarding links X_{XBB}, X_{BBY} to be measured are stored (S290).

Optionally, if the common hop latency from all the ascertained hop latencies of all the single-hop data forwarding links to be measured is specified by a master data network node 110M during initialization, the following additional steps can be performed: In step S2100, the ascertained hop latencies d_{H_XBB}, d_{H_BBY} of all the single-hop data forwarding links X_{XBB}, X_{BBY} to be measured are transmitted to the master data network node 110M. After the master data network node 110M, in step S2110, has received the respectively ascertained hop latencies d_{H_XZZ}, d_{H_ZZY} of the single-hop data forwarding links X_{XZZ}, X_{ZZY} of all the slave data network nodes 110S to be measured, the latter specifies, in step S2120, the common hop latency d_{CH} from the transmitted hop latencies d_{H_XZZ}, d_{H_ZZY}, with the predetermined fixed common hop latency d_{CH} being greater than all the transmitted hop latencies d_{H_XZZ}, d_{H_ZZY}.

FIG. 8 further illustrates the method provided by the invention for synchronizing a synchronized data network system 10 with at least one master data network node 110M and slave data network nodes 110S, said method including the following steps:

Thus, in step S310, synchronization data packets SDP with a master clock time stamp tₜₓ are transmitted by the master data network node 110M to the slave data network nodes 110S at a time tₜₓ. In step S320, the slave data network nodes 110S receive synchronization data packets SDP with a master clock time stamp tₜₓ sent by the master data network node 110M with a master clock CLK_M. Having received a synchronization data packet SDP, the slave clock CLK_S of the slave data network node 110S is then, in step S330, synchronized with the master clock time in accordance with the completed number of hops h of the synchronization data packet SDP between master data network nodes 110M and slave data network nodes 110S, as well as by means of the common deterministic hop latency period d_{CH} according to the formula tₘₐₛₜₑᵣ=tₜₓ+d_{CH}*h.

In accordance with the invention, a synchronized data network system 10, a master data network node 110M and a slave data network node 110S are also provided that are adapted to carry out the above initialization or synchronization methods according to the invention.

1-15. (canceled)

16. A synchronized data network system, comprising:
a data network that connects data network nodes to one another via direct bidirectional data transmission links between neighboring data network nodes for an exchange of data,
wherein a node chain of the data network nodes includes successive first, second and third data network nodes,
wherein the second data network node is configured to receive data transmitted on a first direct data transmission link between the first and the second data network nodes from the first data network node on a data forwarding link, and to forward the data in a transmit mode to the third data network node on a second direct data transmission link between the second and the third data network nodes,
wherein the second data network node is configured to delay forwarding of the data on a single-hop data forwarding link between the first and the third data network nodes, such that a hop latency for the single-hop data forwarding link is equal to a hop latency which is identical, predetermined, fixed and common for all data network nodes of the data network system that forward data between data network nodes of the data network system and which is not dependent on network-specific or node-specific latencies.

17. The synchronized data network system of claim 16, further comprising:
a master data network node with a master clock that is configured to transmit synchronization data packets with a master clock time stamp tₜₓ to slave data network nodes and to synchronize slave clocks of the slave data network nodes with the master clock time in accordance with a completed number of hops h of the synchronization data packets between master data network nodes and the respective slave data network node, as well as by a common hop latency period d_{CH} according to the formula: tₘₐₛₜₑᵣ=tₜₓ+d_{CH}*h.

18. The synchronized data network system of claim 16, wherein the single-hop data forwarding link corresponds to a data forwarding link, which, starting on a transmitter side of the first data network node, passes through the second data network node via the direct data transmission link between the first and the second data network nodes and ends on a transmitter side of the second data network node.

19. The synchronized data network system of claim 16, wherein the single-hop data forwarding link corresponds to a data forwarding link, which, starting on a receiver side of the second data network node, passes through the second data network node and ends, via the direct data transmission link between the second and the third data network nodes, on a receiver side of the third data network node.

20. The synchronized data network system of claim 16, wherein the second data network node comprises:
a data transmitting unit connected to a direct data transmission link in order to transmit data to other data network nodes;
a data receiving unit connected to a direct data transmission link in order to receive data from other data network nodes;
a latency matching unit configured to calculate, based on a stored specific hop latency of the current single-hop data forwarding link and the predetermined fixed common hop latency period, a latency matching period specific to the current single-hop data forwarding link; and
a delay buffer interposed between the data receiving unit and the data transmitting unit and configured to delay forwarding of data packets on the current single-hop data forwarding link by the latency matching period received from the latency matching unit.

21. The synchronized data network system of claim 20, wherein the latency matching unit comprises:
a timer configured to measure a roundtrip latency (d_{RT}) on a single-hop data forwarding link to be measured;
a memory configured to store an intrinsic node latency (d_{SRX_B}) of the second data network node, roundtrip latencies (d_{RT}) of the single-hop data forwarding links of the second data network node, and the predetermined fixed common hop latency (d_{CH}); and
a calculation unit configured to calculate the latency matching period (d_{ARX}) according to the formula: d_{ARX}=d_{CH}−d_{RT}/2−d_{SRX_B}.

22. The synchronized data network system of claim 16, wherein the second data network node comprises a communication control unit configured to control initialization and synchronization, including:
an initialization control unit configured to control an initialization process of the data network nodes; and
a synchronization control unit configured to control synchronization of the data network nodes.

23. The synchronized data network system of claim 22, wherein the initialization control unit is configured to prompt the second data network node as the slave data network node to perform the following steps:
transmitting a roundtrip measurement command from the communication control unit to the data transmitting unit;
transmitting, by the data transmitting unit, a roundtrip signal or ping signal to a data receiving unit of a corresponding receiving data network node via a corresponding direct data transmission link of a single-hop data forwarding link to be measured;
starting a timer by the latency matching unit upon transmission of the roundtrip signal;
receiving, by the data receiving unit, the roundtrip signal sent back from the corresponding data network node via the corresponding direct data transmission link;
stopping the timer by the latency matching unit upon receipt of the roundtrip signal sent back;
reading the roundtrip latency from the timer;
calculating the specific hop latency of the single-hop data forwarding link to be measured by adding the intrinsic node latency to half the roundtrip latency;
repeating each of the above steps for all of the single-hop data forwarding links to be measured; and
storing the hop latencies calculated for all of the single-hop data forwarding links to be measured.

24. The synchronized data network system of claim 22, wherein the synchronization control unit is configured to prompt the second data network node as the slave data network node to perform the following steps:
receiving, from a master data network node with a master clock, synchronization data packets with a master clock time stamp tₜₓ; and
synchronizing the slave clock of the second data network node with the master clock time in accordance with the completed number of hops h of the synchronization data packet between master data network nodes and the second data network node, as well as by the common deterministic hop latency period d_{CH} according to the formula tₘₐₛₜₑᵣ=tₜₓ+d_{CH}*h.

25. The synchronized data network system of claim 24, wherein the synchronization data packet, in addition to the master clock time stamp, includes the number of hops and an identifier of the master data network node.

26. The synchronized data network system of claim 22, wherein the synchronization control unit is configured to prompt the second data network node as the master data network node to perform the following steps:
transmitting, at a time tₜₓ₁, synchronization data packets with a master clock time stamp tₜₓ to the slave data network nodes.

27. The synchronized data network system of claim 26, wherein the synchronization data packet, in addition to the master clock time stamp, includes the number of hops and an identifier of the master data network node.

28. The synchronized data network system of claim 16, wherein the synchronized data network system is an avionics system data network for deterministic communication between the data network nodes.

29. A method for initializing a synchronized data network system, the method comprising the following steps:
transmitting a roundtrip measurement command from a communication control unit of a slave data network node to a data transmitting unit of the slave data network node;
transmitting, by the data transmitting unit of the slave data network node, a roundtrip signal or ping signal to a data receiving unit of a corresponding additional slave data network node via a corresponding direct data transmission link of a single-hop data forwarding link to be measured;
starting a timer of the slave data network node upon transmission of the roundtrip signal or ping signal by a latency matching unit of the slave data network node;
receiving, by a data receiving unit of the slave data network node, the roundtrip signal or ping signal sent back from the corresponding additional slave data network node via the corresponding direct data transmission link;
stopping the timer by the latency matching unit of the slave data network node upon receipt of the roundtrip signal or ping signal sent back;
reading the roundtrip latency from the timer of the slave data network node;
calculating a hop latency of the single-hop data forwarding link to be measured by adding an intrinsic node latency of the second data network node to half the roundtrip latency;
repeating each of the above steps for all of the single-hop data forwarding links to be measured;
storing the hop latencies calculated for all of the single-hop data forwarding links to be measured; and
delaying forwarding of data on the single-hop data forwarding links such that the hop latency becomes equal to a hop latency, which is identical, predetermined, fixed and common for all data network nodes of the data network system that forward data between data network nodes of the data network system, and which is not dependent on network-specific or node-specific latencies.

30. A method for synchronizing a synchronized data network system comprising at least one master data network node and slave data network nodes, the method comprising the following steps:
transmitting, through the master data network node at a time tₜₓ₁, synchronization data packets with a master clock time stamp tₜₓ to the slave data network nodes;
receiving, through the slave data network nodes, synchronization data packets with a master clock time stamp tₜₓ from the master data network node with a master clock;
synchronizing the slave clock of the slave data network node with the master clock time in accordance with a completed number of hops h of the synchronization data packet between master data network nodes and slave data network nodes, and by a hop latency d_{CH}, which is identical, predetermined, fixed and common for all data network nodes of the data network system that forward data between data network nodes of the data network system and which is not dependent on network-specific or node-specific latencies, according to the formula: tₘₐₛₜₑᵣ=tₜₓ+d_{CH}*h.
